(19) United States
(12) Patent Application Publication
(10) Pub. No.: US 2022/0356328 A1
(43) Pub. Date: Nov. 10, 2022

(54) Polyamide Composition and the Article Thereof

(71) Applicant: BASF SE, Ludwigshafen am Rhein (DE)

(72) Inventors: Lin CHEN, Shanghai (CN); Wen LU, Shanghai (CN); Suresh PARAPPUVEETIL SARANGADHARAN, Shanghai (CN); Fu Chin CHUANG, Yokohama-shi (JP)

(21) Appl. No.: 17/754,331

(22) PCT Filed: Oct. 7, 2020
(86) PCT No.: PCT/EP2020/078026

§ 371 Date: Mar. 30, 2022

(30) Foreign Application Priority Data
Oct. 8, 2019 (CN) PCT/CN2019/109990

(51) Int. Cl. C08K 13/02

(52) U.S. Cl. CPC C08K 13/02

(57) ABSTRACT

Disclosed herein is a polyamide composition, and an article which is obtained or obtainable from the composition. The article may include a connector socket for Double Data Rate 5 RAM. The polyamide composition disclosed herein shows desirable tensile strength for the article at a thickness of 0.4 mm, good flowability, and high HDT. The composition also exhibits good thermal stability during molding, and approaches UL 94 V-0.

### TECHNICAL FIELD

The present invention relates to a polyamide composition, and also relates to an article which is obtained or obtainable from the polyamide composition, especially the connector socket for Double Data Rate 5 RAM.

### BACKGROUND

In recent years, surface mounting technology (SMT), which is basically a component assembly technology relating to producing electronic circuits in which the components are mounted or placed directly onto the surface of printed circuit boards (PCBs) using batch solder-reflow processes, has been rapidly developed. A printed circuit board where paste solder is applied beforehand, and a component such as chip is mounted on the board. The boards are then conveyed into the reflow soldering oven and the paste is melted by heating it to about 250° C. (solder reflow process), and the component is bonded on the printed circuit board. SMT differs from other PCB methods where the component leads are inserted into plated through-holes and wave-soldered from the bottom to fill in the holes and interconnect the components. SMT components are usually smaller than through-hole counterpart because it has either smaller leads or no leads at all. SMT has the advantages of miniaturization of electronic components, higher package density, efficiency of soldering process, reduced cost than the plated through-hole insertion process, which leads to the essential role of SMT in leading electronic products towards miniaturization and light weight.

The development of the electric and electronic field requires higher working frequency and lower height of the electric components to realize higher speed of electric components and higher density of circuit boards. This leads to the difficulties in molding, crosstalk, reflow soldering, and higher requirement on size reliability and heat stability. The general working frequency of DDR 4 RAM (random access memory) is about 3.2 GHz, it was found that the resin materials for the DDR 4 RAM have a lot of disadvantage when applied into higher working frequency or smaller size.

Electronic components are usually obtained by molding resin materials via injection molding or the like. When electronic components become thinner or lower, problem of short shot occurs because of incomplete filling of a mold cavity which is caused by the poor flowability of the resin material. Therefore, higher flowability is required when the resin materials are used for electronic components with smaller size.

Aliphatic polyamides have been used in many electric components because of good mechanical properties, such as moldability, rigidity, wear resistance. However, as typical aliphatic polyamide, Nylon 6 and Nylon 66 have insufficiency in heat resistance and dimensional stability. Nylon 46 or semi-aromatic polyamide was developed with good heat resistance acceptable to reflow solder process by SMT. But the high water-absorbency of Nylon 46 brings blisters during the soldering process or during the use period and problems such as dimensional change and physical property deterioration of the molded articles. Semi-aromatic polyamide, due to its low water absorption, shows promising performance in those two aspects, but its inadequate flowability can hardly meet the processing and structuring requirement of thin wall electric component.

In the E&E fields, a high flame retardancy standard as V-0 class in the UL-94 standard is required, which leads high requirement of flame retardancy to polyamide resin. In the vertical burning test of V-0 class, it is required that the burning stops within 10 seconds on a vertical specimen, and drips of particles are allowed as long as the cotton is not ignited by the drips. In general, the increase of flowability sacrifices the flame retardancy. When the flowability of the resin material is raised, the melt tension becomes decrease at the vertical burning, as a result, cotton is ignited by dripping burning resin to the cotton, and the flame retardance become V-2 class. Anti-dipping agent comprising fluorine resin and an ionomer, and/or a modified aromatic vinyl-based polymer was applied to the polyamide composition to compensate the flame retardancy in EP 2180018B.

The polyamide composition used for SMT connector was disclosed by JP2011116889A. The polyamide resin is made from carboxylic acid component comprising oxalic acid, and the diamine components of 1,9-nonanediamine and mixture of 2-methyl-1,8-octane diamine and 1,6-hexanediamine. The composition could fulfill the requirement of flowability however it's hard to approach the flame retardancy for Double Data Rate 5 (DDR 5) application.

JP2007138151A disclosed a polyamide composition comprising 100 parts of polyamide resin, at least 5 to 70 parts of at least one selected from a phosphazene compound and a phosphinate, and at least 0.1 to 15 parts of at least one selected from silica, coal ash, zeolite and silicate. However, in this document, only phosphazenes are virtually used as a flame-retardant component. There is a large difference in melting point between phosphazene and high-melting point polyamide resin with a melting point of 280° C. or higher (particularly 310° C. or higher). This causes large reduction in knead-ability of an extruder of the like, as well as difficulty in ensuring high flame retardancy comparable to the UL 94 V-0 requirements in 1/32 inch-thick (0.8 mm) molded articles.

A combination of phosphinates and phosphazenes are used to improve the flame retardant and flowability of the aromatic polyamide. WO 2009/037859 describes flame retardant polyamides comprising 20-80 wt % of polyamide with Tm from 280 to 340° C., 5-30 wt % of a phosphinate compound, and 0.01-10 wt % of a phosphazene compound. It's seen from the embodiments of 1-4, the combination of phosphinate and phosphazene improve the flowability and flame retardancy, but the flexural strength was sacrificed. It is observed that the mechanical scarification will be critical especially when the size of the electronic components further reduced.

Synergistic combination of phosphinates, salt of phosphorous acid is used in US2018/0072873A1 to further improve the flame retardancy of polyamide composition. The patent application describes a polyamide composition comprising 1-96 wt % of a polyamide, 2-25 wt % of a dialkylphosphinic salt and/or a diphosphinic salt, 1-20 wt % of a salt of phosphorous acid, 1-20 wt % of a phosphazene, 0-50 wt % of filler or reinforcing agent. However, aliphatic polyamide can't afford the high temperature of the reflow soldering process when used to SMT components when virtually used.

It was observed that smaller size thin-wall articles are easier to crack during the insert of electronic element, such as memory chips. There is a need to find a suitable material which could solve the crack problem and solve the problems described above.

### SUMMARY OF THE INVENTION AND ADVANTAGES

The aim of the present invention is therefore to provide a polyamide composition and article thereof that has good flame retardancy, tensile property and flowability, to realize the thin wall articles which has maximum working frequency of higher than 3.2 GHz, especially for the DDR 5 application.

Contrary to the conventional knowledge that flowability and tensile property are hard to be improved simultaneously, it is surprisingly found by the inventors that the polyamide composition in the present invention has outstanding tensile property especially in the low height articles and high working frequency articles, the flowability is also increased, and flame retardancy could approach UL 94 V-0 standard, which makes the polyamide composition prospective in such application.

The aim has been achieved with a polyamide composition comprising as component (A) 30 to 55 wt % of one or more long chain semi-aromatic polyamides, as component (B) 10 to 20 wt % of flame-retardant system, as component (C) 1 to 4.8 wt % of phosphazene and as component (D) 30 to 50 wt % of reinforcing agent, based on the total weight of the polyamide composition, wherein the flame-retardant system comprising (B-1) dialkylphosphinate of formula (I) and/or diphosphinic salt of formula (II) and (B-2) metal salt of phosphorous acid;

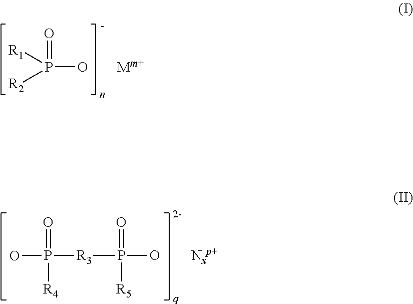

R₁ and R₂ are identical or different and are linear or branched C₁-C₆-alkyl, preferable is linear or branched C₁-C₄ alkyl, more preferable is methyl, ethyl or propyl;
M or N is Mg, Ca, Al, Sb, Sn, Ge, Ti, Zn, Fe, Zr, Ce, Bi, Sr, Mn, Li, Na, K, a protonated nitrogen base or a mixture thereof, preferable is Mg, Ca, Al, Zn, or a mixture thereof; m is integer of 1 to 4; n is integer of 1 to 4;
R₃ is linear or branched C₁-C₁₀-alkylene, C₆-C₁₀-arylene, C₇-C₂₀-alkylarylene or C₇-C₂₀-arylalkylene, preferable is linear or branched C₁-C₄-alkylene or C₆-C₁₀-arylene;
R₄ and R₅ are identical or different and are linear or branched C₁-C₆-alkyl, preferable is linear or branched C₁-C₄ alkyl, more preferable is methyl, ethyl or propyl; q is integer of 1 to 4; p is integer of 1 to 4; x is integer of 1 to 4.

The other aim of the present invention is to provide a process for the production of polyamide composition.

The other aim of the present invention is therefore to provide an article which is obtained or obtainable by the polyamide composition, especially the DDR 5 components.

In the invention, the terms “a”, “an” and “the” are used interchangeable with the term “at least one”. The phrases “at least one of” and “comprises at least one of” followed by a list refers to any one of the items in the list and any combination of two or more item in the list. All numerical ranges are inclusive of their endpoints and non-integral values between the endpoints unless otherwise stated.

In the invention, the “main chain” means the linear backbone chain of a polymer, which is the longest series of covalently bonded atoms that together create the continuous chain of the molecule.

### DETAILED DESCRIPTION OF THE INVENTION

Disclosed is a polyamide composition, comprising as component (A) 30 to 55 wt % of one or more long chain semi-aromatic polyamides, as component (B) 10 to 20 wt % of flame-retardant system, as component (C) 1 to 4.8 wt % of phosphazene and as component (D) 30 to 50 wt % of reinforcing agent, based on the total weight of the polyamide composition, wherein the flame-retardant system comprising (B-1) dialkylphosphinate of formula (I) and/or diphosphinic salt of formula (II) and (B-2) metal salt of phosphorous acid;

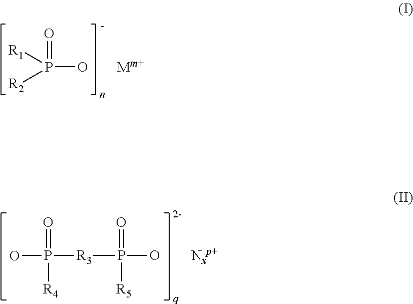

R₁ and R₂ are identical or different and are linear or branched C₁-C₆-alkyl, preferable is linear or branched C₁-C₄ alkyl, more preferable is methyl, ethyl or propyl;
M or N is Mg, Ca, Al, Sb, Sn, Ge, Ti, Zn, Fe, Zr, Ce, Bi, Sr, Mn, Li, Na, K, a protonated nitrogen base or a mixture thereof, preferable is Mg, Ca, Al, Zn, or a mixture thereof; m is an integer of 1 to 4; n is an integer of 1 to 4;
R₃ is linear or branched C₁-C₁₀-alkylene, C₆-C₁₀-arylene, C₇-C₂₀-alkylarylene or C₇-C₂₀-arylalkylene, preferable is linear or branched C₁-C₄-alkylene or C₆-C₁₀-arylene;
R₄ and R₅ are identical or different and are linear or branched C₁-C₆-alkyl, preferable is linear or branched C₁-C₄ alkyl, more preferable is methyl, ethyl or propyl;
q is an integer of 1 to 4; p is an integer of 1 to 4; x is an integer of 1 to 4.

The long chain semi-aromatic polyamides in the present invention could be derived from dicarboxylic acids, diamines, and optional amino acids and/or lactams, wherein the dicarboxylic acids comprising at least one aromatic dicarboxylic acid and the diamines comprising at least one aliphatic diamine having at least 8 carbon number, or the dicarboxylic acids comprising at least one aliphatic dicarboxylic acid having at least 8 carbon number and the diamines comprising at least one aromatic diamine.

In one preferred embodiment of the invention, the long chain semi-aromatic polyamides in the present invention includes polyamide (i) and/or polyamide (ii),

wherein polyamide (i) could be derived from monomers comprising (A-1) dicarboxylic acids which comprise 60-100 mol % of terephthalic acid based on the total amount of the dicarboxylic acids, (A-2) diamines which comprise as component (a) aliphatic diamine having at least 8 carbon number in an amount of 60-100 mol % based on the total amount of the diamines, and optional (A-3) amino acid and/or lactam;
polyamide (ii) could be derived from monomers comprising (A-4) dicarboxylic acids which comprise 60-100 mol % of aliphatic dicarboxylic acid having at least 8 carbon number based on the total amount of the dicarboxylic acids, (A-5) diamines which comprise 60-100 mol % of aromatic diamine based on the total amount of the diamines, and optional (A-3) amino acid and/or lactam.

In one preferred embodiment of the invention, the long chain semi-aromatic polyamides in the present invention is polyamide (i) or the copolyamide of polyamide (i).

In one preferred embodiment of the invention, the long chain semi-aromatic polyamides in the present invention is polyamide (ii) or the copnolyamide of polyamide (ii).

### Polyamide (i)

Except for the terephthalic acid (“TPA”), the suitable dicarboxylic acids (A-1) in the present invention could also comprise aromatic dicarboxylic acid other than terephthalic acid, aliphatic and/or cycloaliphatic dicarboxylic acid, preferable is other aromatic and/or aliphatic dicarboxylic acid.

The other aromatic dicarboxylic acid preferably comprises from 8 to 20 carbon atoms, more preferable from 8 to 14 carbon atoms, such as isophthalic acid, naphthalenedicarboxylic acids and/or diphenyldicarboxylic acids.

The aliphatic dicarboxylic acid preferably comprises from 4 to 36 carbon atoms, more preferable from 5 to 36 carbon atoms, most preferable from 5 to 18 carbon atoms or 36 carbon atoms. Examples of the aliphatic dicarboxylic acid are succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanoic acid, hexadecanedioic acid, octadecanedioic acid and C36 dimer acid.

The cycloaliphatic dicarboxylic acid is preferably at least one cycloaliphatic acid comprising at least one carbon backbone selected from the group consisting of cyclohexane, cyclopentane, cyclohexylmethane, dicyclohexylmethane, bis(methylcyclohexyl), more preferably is selected from the group consisting of cis- and trans- cyclopentane-1,3-dicarboxylic acid, cis- and trans-cyclopentane-1,4-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid.

The suitably dicarboxylic acid of polyamide (i) is terephthalic acid, and optional one dicar-boxylic acid selected from the group consisting of isophthalic acid, succinic acid, glutaric acid, adipic acid, pimelic acid, suberic acid, azelaic acid, sebacic acid, undecanedioic acid, dodeca-nedioic acid, tridecanedioic acid, tetradecanedioic acid, pentadecanoic acid, hexadecanedioic acid, octadecanedioic acid and C36 dimer acid.

Except for the aliphatic diamine (a), the suitable diamine (A-2) in the present invention could also comprise other aliphatic diamines having less than 8 carbon number, cycloaliphatic and/or aromatic diamine.

The aliphatic diamine (a) having at least 8 carbon number could be linear aliphatic diamine (a) or branched aliphatic diamine (a), preferably is linear aliphatic diamine (a). The aliphatic diamine (a) preferably comprise from 8 to 36, more preferably from 8 to 22 carbon atoms or 36 carbon atoms.

Examples of the linear aliphatic diamines (a) are 1,8-octanediamine, 1,9-nonanediamine, 1,10-decanediamine, 1,11-undecanediamine, 1,12-dodecanediamine, 1,13-tridecanediamine, 1,14-tetradecanediamine, 1,16-hexadecanediamine, 1,18-octadecanediamine, 1,20-eicosanediamine and 1,22-docosanediamine.

The nitrogen atoms in the branched aliphatic diamine (a) are separated by an alkylene main chain substituted with alkyl groups. The alkyl groups in the alkylene main chain is preferably C₁-C₄ alkyl group, such as methyl or ethyl group. Examples of the branched aliphatic diamines (a) are 2-methyl-1,8-octanediamine, 5-methylnonane-1,9-diamine and 2,4-dimethyloctanediamine.

The aliphatic diamine (a) is preferably selected from the group consisting of 1,8-octanediamine, 1,9-nonanediamine, 1,10-decanediamine, 1,11-undecanediamine, 1,12-dodecanediamine, 1,13-tridecanediamine, 1,14-tetradecanediamine, 1,16-hexadecanediamine, 1,18-octadecanediamine, 1,20-eicosanediamine , 1,22-docosanediamine , 2-methyl-1,8-octanediamine, 5-methylnonane-1,9-diamine and 2,4-dimethyloctanediamine.

The other aliphatic diamines having less than 8 carbon number in the present invention is preferable linear aliphatic diamine having from 4 to 7 carbon atoms and/or branched aliphatic diamine having from 4 to 7 carbon atoms. Examples of the other aliphatic diamine are butanediamine, pentanediamine, hexanediamine, heptanediamne, 2-methylpentanediamine, 2,2,4-trimethylhexamethylenediamine and 2,4,4-trimethylhexamethylenediamine.

In polyamide (i), the amount of the terephthalic acid is 60 mol % or more, preferably is 65 mol % or more, 70 mol % or more, or 75 mol % or more, more preferable is 80 mol % or more, and is 100mol % or less, preferably is 98 mol % or less, 95 mol % or less, 90 mol % or less, or 85 mol % or less; the preferable amount of the terephthalic acid is from 80 mol % to 100 mol %, based on the total amount of the dicarboxylic acid.

In one preferred embodiment, the polyamide (i) could be derived from monomers comprising (A-1) dicarboxylic acids which comprise 80-100 mol % of terephthalic acid, and 0-20 mol % of other dicarboxylic acids selected from the group consisting of isophthalic acid, succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanoic acid, hexadecanedioic acid, octadecanedioic acid and C36 dimer acid; based on the total amount of the dicarboxylic acids;

(A-2) diamines which comprise as component (a) aliphatic diamine selected from the group consisting of 1,8-octanediamine, 1,9-nonanediamine, 1,10-decanediamine, 1,11-undecanediamine, 1,12-dodecanediamine, 1,13-tridecanediamine, 1,14-tetradecanediamine, 1,16-hexadecanediamine, 1,18-octadecanediamine, 1,20-eicosanediamine , 1,22-docosanediamine, 2-methyl-1,8-octanediamine, 5-methylnonane-1,9-diamine and 2,4-dimethyloctanediamine, in an amount of 60-100 mol % based on the total amount of the diamines.

### Polyamide (ii)

Except for the aliphatic dicarboxylic acid having at least 8 carbon number, the suitable dicarboxylic acids (A-4) in the present invention could also comprise aliphatic dicarboxylic acid having from 4 to 7 carbon number, aromatic and/or cycloaliphatic dicarboxylic acid.

The aliphatic dicarboxylic acid having at least 8 carbon number preferably have from 8 to 36 carbon atoms, more preferably have from 9 to 18 carbon atoms or 36 carbon atoms. Examples of the aliphatic dicarboxylic acid are pimelic acid, suberic acid, azelaic acid, sebacic acid, undecanedioic acid, dodecanedioic acid, tridecanedioic acid, tetradecanedioic acid, pentadecanoic acid, hexadecanedioic acid, octadecanedioic acid and C36 dimer acid.

The examples of the aliphatic dicarboxylic acid having from 4 to 7 carbon atoms are succinic acid, glutaric acid and/or adipic acid.

The aromatic dicarboxylic acid preferably comprises from 8 to 20 carbon atoms, more preferable from 8 to 14 carbon atoms, such as terephthalic acid, isophthalic acid, naphthalenedicarboxylic acids and/or diphenyldicarboxylic acids.

Except for aromatic diamine, the suitable diamine (A-5) in the present invention could also comprise aliphatic and/or cycloaliphatic diamine.

The suitable aromatic diamine in the present invention is preferably selected from the group comprising m-xylylenediamine(MXDA), p-xylylenediamine, bis(4-aminophenyl)methane, 3-methylbenzidine, 2,2-bis(4-aminophenyl)propane, 1,1-bis(4-aminophenyl)cyclohexane, 1,2-diaminobenzene, 1,3-diaminobenzene, 1,4-diaminobenzene, 1,2-diaminonaphthalene, 1,3-diami nonaphthalene, 1,4-diaminonaphthalene, 2,3-diaminotoluene, N,N′-dimethyl-4,4′-bephenyldiamine, bis(4-methylaminophenyl)methane and 2,2′-bis(4-methylaminophenyul)propane.

The aliphatic diamine of polyamide (ii) in the present invention preferably has from 4 to 36 carbon atoms, more preferably from 8 to 36, most preferably from 8 to 22 or 36 carbon atoms. The examples of the aliphatic diamine in polyamide (ii) are octanediamine, nonanediamine, decanediamine, undecanediamine, dodecanediamine, tridecanediamine, tetradecanediamine, hexadecanediamine, octadecanediamine, eicosanediamine, docosanediamine, 2-methyl-1,8-octanediamine, 5-methylnonane-1,9-diamine, 2,4-dimethyloctanediamine, butanediamine, pentanediamine, hexanediamine, heptanediamne, 2-methylpentanediamine, 2,2,4-trimethylhexamethylenediamine, and 2,4,4-trimethylhexamethylenediamine.

The cycloaliphatic dicarboxylic acid in the polyamide (i) or polyamide (ii) is independently preferably comprises at least one carbon backbone selected from the group consisting of cyclohexane, cyclopentane, cyclohexylmethane, dicyclohexylmethane and bis(methylcyclohexyl). Examples of the cycloaliphatic dicarboxylic acid are cis- and trans-cyclopentane-1,3-dicarboxylic acid, cis- and trans-cyclopentane-1,4-dicarboxylic acid, cis- and trans-cyclohexane-1,2-dicarboxylic acid, cis- and trans-cyclohexane-1,3-dicarboxylic acid, and cis- and trans-cyclohexane-1,4-dicarboxylic acid.

The cycloaliphatic diamine in the polyamide (i) or polyamide (ii) is independently preferably selected from the group comprising bis(3,5-dialkyl-4-aminocyclohexyl)methane, bis(3,5-dialkyl-4-aminocyclohexyl) ethane, bis(3,5-dialkyl-4-aminocyclohexyl)propane, bis(3,5-dialkyl-4-aminocyclohexyl) butane, bis(3-methyl-4-aminocyclohexyl)methane (BMACM or MACM), p-bis(aminocyclohexyl) methane (PACM), isopropylidenedi(cyclohexylamine) (PACP) and isophoronediamine (IPDA).

The suitable amino acid in the present invention preferably comprises from 4 to 12 carbon atoms. Examples of the amino acid are 4-aminobutanoic acid, 6-aminocaproic acid, 7-aminoheptanoic acid, 8-aminooctanoic acid, 10-aminodecanoic acid, 11-aminoundecanoic acid and 12-aminododecanoic acid.

The suitable lactam in the present invention preferably comprises from 4 to 12 carbon atoms, more preferably from 6 to 12 carbon atoms. Examples of the lactam are 2-pyrrolidone (γ-butyrolactam), 2-piperidone (δ-valerolactam), ε-caprolactam, capryllactam, decanelactam, undecanolactam, enantholactam, and lauryllactam, preferably is ε-caprlactam.

The amount of (A-3) amino acid and/or lactam in polyamide (i) or polyamide (ii) is independently preferably in a range of 0-20 wt %, more preferably is in a range of 10-20 wt %, based on the total amount of monomers for polyamide (i) or polyamide (ii).

In a preferred embodiment, the long chain semi-aromatic polyamide is derived from monomers comprising:
(A-1) 80-100 mol % of terephthalic acid and 0-20 mol % of dicarboxylic acid other than terephthalic, based on the total amount of dicarboxylic acid; the dicarboxylic acid other than terephthalic is selected from the group consisting of isophthalic acid and the aliphatic dicarboxylic acid having 5 to 36 carbon atoms, more preferably from 5 to 18 carbon atoms;
(A-2) 80-100 mol % of aliphatic diamine (a) and 0-20 mol % of the other aliphatic diamine than aliphatic diamine (a) and/or the aromatic diamine, based on the total amount of diamine;
(A-3) 0-20 wt % of the amino acid and/or the lactam based on the total amount of (A-1) to (A-3).

Examples of the long chain semi-aromatic polyamide are PA9T, PA10T, PA11T, PA12T, PA13T and PA14T.

The long-chain semi-aromatic polyamides could be composed of different polyamides, such as copolyamide of polyamide (i), polyamide (ii) and/or one or more other polyamides, together referred to as polyamide (iii).

The copolyamides of polyamide (i) could be represented as PA XT/MY. Herein “T” represents terephthalic acid, “X” and “M” represents carbon number of diamines, and “Y” represents a dicarboxylic acid. Examples of PA XT/MY are PA6T/8T, PA10T/6T, PA10T/610, PA6T/610, PA5T/510 and PA4T/410.

The long chain semi-aromatic polyamide preferable is crystalline and has a melting point (Tm), preferably is higher than 280° C., more preferably 285° C.-330° C., most preferably 305° C.-315° C. The melting point is defined as a temperature corresponding to an endothermic peak in a differential scanning calorimetry (DSC) curve, which is obtained by heating polyamide at a heating rate of 10° C./min using a DSC.

The suitable long chain semi-aromatic polyamide could be GENESTAR™ PA9T from Kuraray, Vicnyl™ PA10T from Kingfa, Grivory HT™ PA10T/X from EMS, and Vestamid HTplus PA10T/X from Evonik.

The long chain semi-aromatic polyamide in the present invention preferably has the viscosity number of 60˜120 ml/g, which is measured in 96 wt % H₂SO₄ according to ISO307-2007 method.

The amount of the long chain semi-aromatic polyamides (A) is from 30 wt % to 55 wt %, based on the total weight amount of the polyamide composition, preferably is from 30 wt % to 50 wt %, more preferably is from 35 wt % to 50 wt %, most preferably from 40 wt % to 50 wt %, such as 37 wt %, 39 wt %, 41 wt %, 43 wt %, 44 wt %, 45 wt %, 46 wt %, 48 wt %, or 50 wt %.

Examples of dialkylphosphinate of formula (I) include calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphoshinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate and zinc methyl-n-propylphosphinate. Among them, aluminum diethylphosphinate, zinc diethylphosphinate, aluminum dimethylphosphinate and zinc dimethylphosphinate are more preferable.
Examples of diphosphinic salt of formula (II) include calcium methanedi(methylphosphinate), magnesium methanedi(methylphosphinate), aluminum methanedi(methylphosphinate), zinc methanedi(methylphosphinate), calcium benzene-1,4-(dimethylphosphinate), magnesium benzene-1,4-(dimethylphosphinate), aluminum benzene-1,4-(dimethylphosphinate) and zinc benzene-1,4-(dimethylphosphinate).
The metal salt of phosphorous acid (B-2) in the present invention preferable comprises the structural unit of formula (III) or (IV):

[HPO₃]ᵣ^{2-T}_{z}^{w+} (III)

[H₂PO₃]ᵣ⁻T_{z}^{w+} (IV)

wherein T is Mg, Ca, Al, Sb, Sn, Ge, Ti, Zn, Fe, Zr, Ce, Bi, Sr, Mn, Li, Na, K, a protonated nitrogen base or a mixture thereof, preferable is Al and/or Zn; r is 1 to 4; w is 1 to 4; z is 1 to 7, preferably is 1 to 4.

Examples of melt salt of phosphorous acid are Al(H₂PO₃)₃, Al₂(HPO₃)₃, Zn(HPO₃), Al2(HPO₃)₃.4H₂O and Al(OH)(H₂PO₃)₂.2H₂O, preferable is Al₂(HPO₃)₃.

The components (B-1) and (B-2) are preferably in a mass ratio of (B-1)/(B-2) from 60:40 to 90:10, for example 85:15, 80:20, or 75:25.

The amount of the component (B-1) in the present invention is preferably from 6 wt % to 18 wt %, such as 10 wt %, 12 wt %, 13 wt %, 14 wt %, based on the total weight amount of the polyamide composition. The amount of the component (B-2) in the present invention is preferably from 2 wt % to 8 wt %, such as 3 wt %, 4 wt %, based on the total weight amount of the polyamide composition.

The amount of the flame-retardant system (B) is from 10 wt % to 20 wt %, preferable from 12 wt % to 19 wt %, such as 14 wt %, 15 wt %, 16 wt %, 17 wt %, 18 wt % or 19 wt %, based on the total weight amount of the polyamide composition.

The polyamide composition in the present invention could approach UL-94 V-0 flame retardancy effect without the addition of other flame retardant or flame-retardant synergist.

The phosphazene (C) in the present invention is at least one phosphazene selected from a cyclic phosphazene having the formula (V), a linear phosphazene having the formula (VI), and at least one phosphazene obtained by cross-linking the cyclic phosphazene or the linear phosphazene with a cross-linking group.

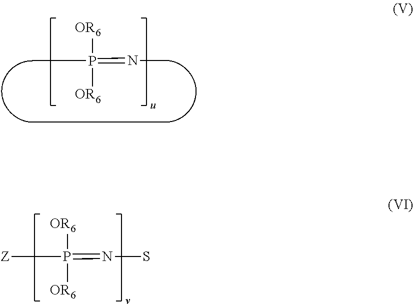

wherein each R₆ is identical or different and is C₁-C₂₀-alkyl, C₆-C₂₀-aryl, C₇-C₃₀-arylalkyl, or C₇-C₃₀-alkylaryl, preferably is C₆-C₃₀-aryl or C₇-C₃₀-alkylaryl; u is an integer of from 3 to 25, preferable is from 3 to 6; v is an integer of from 3 to 10,000; Z is —N═P(OR₆)₃ or —N═P(O)OR₆; S is —P(OR₆)₄ or —P(O)(OR₆)₂.

The aryl denoted by R₆ is preferable C₆-C₁₅, more preferable C₆-C₁₂-aryl. Examples of the aryl denoted by R₆ include phenyl; naphthyl; biphenylyls such as o-phenylphenyl, m-phenylphenyl and p-phenylphenyl; alkoxyphenyls such as o-methoxyphenyl, m-methoxyphenyl and p-methoxyphenyl; hydroxyphenyls such as o-hydroxyphenyl, m-hydroxyphenyl, o-hydroxyphenyl; (hydroxyaryl)alkylaryls such as p-[2-(p′-hydroxyphenyl) isopropyl]phenyl; (hydroxyarylsulfonyl) aryls such as p-(p′-hydroxyphenylsulfonyl)phenyl; (hydroxyaryloxy)aryls such as p-(p′-hydroxyphenyloxy)phenyl; glycidylphenyl; and cyanophenyl; preferable is phenyl or cyanophenyl.

The alkylaryl denoted by R₆ is preferable (C₁-C₁₀)alkyl(C₆-C₂₀) aryl, more preferable is (C₁-C₃)alkylphenyl. Examples of the alkylaryl denoted by R₆ or R₇ include tolyls such as o-tolyl, m-tolyl, p-tolyl; xylyls such as 3,4-xylyl, 3,5-xylyl, 2,3-xylyl, 2,4-xylyl, 2,5-xylyl and 2,6-xylyl); ethylphenyls; butylphenyls such as 2-t-butylphenyl, 4-t-butylphenyl, 2,4-di-t-butylphenyl, 2,6-di-t-butylphenyl, 3-methyl-6-t-butylphenyl and 2,6-di-t-butyl-4-methylphenyl; aminophenyls such as 2,4-di-t-aminophenyl and 2,6-di-t-aminophenyl; cyclohexylphenyls; trimethylphenyls; and methylnaphthyls; preferable is o-tolyl, m-tolyl, p-tolyl, 2,4-xylyl, 2,6-xylyl and 3,5-xylyl.

Examples of cyclic and/or linear phosphazene having formula (V) or (VI) include cyclic and/or linear (C₁-C₆)alkyl(C₆-C₂₀)aryloxyphosphazenes, cyclic and/or linear (C₆-C₂₀)aryl(C₁-C₃)alkyl(C₆-C₂₀)aryloxyphosphazenes and/or cyclic phenoxyphosphazene. Examples of the phosphazene include (poly)tolyoxyphosphazenes such as poly(o-tolyoxyphosphazene), poly(m-tolyoxyphosphazene), poly(p-tolyoxyphosphazene), poly(o,m-tolyoxyphosphazene), poly(o,p-tolyoxyphosphazene), poly(m,p-tolyoxyphosphazene) and poly(o,m,p-tolyoxyphosphazene); (poly)xylyloxyphazene; (poly) methylnaphthyloxyphosphazenes; (poly)phenoxytolyloxyphosphazenes such as poly(phenoxy-o-tolyloxyphosphazene), poly(phenoxy-m-tolyloxyphosphazene), poly(phenoxy-p-tolyloxyphosphazene), poly(phenoxy-o, m-tolyloxyphosphazene), poly(phenoxy-o,p-tolyloxyphosphazene), poly(phenoxy-m, p-tolyloxyphosphazene) and poly(phenoxy-o,m,p-tolyloxyphosphazene); (poly)phenoxyxylyloxyphosphazenes; (poly)phenoxytolyloxyxylyloxyphosphazenes; (poly) phenoxymethylnaphthyloxyphosphazenes and (poly)phenoxyphosphazene.

Phosphazene use in the present invention also encompasses cross-linked phosphazenes obtained by cross-linking at least one kind of phosphazene selected from the above cyclic phosphazene having formula (V) and linear phosphazene having formula (VI) with a cross-linking group. When a pair of phosphazenes is to be cross-linked by a cross-linking group, a divalent cross-linking group is introduced instead of a pair of R₆.

The cross-linking group may be an alkylene or cycloalkylene group but is generally an arylene group. Examples of the arylene group include phenylenes (e.g., 1,2-phenylene, 1,3-phenylene and 1,4-phenylene); naphthylenes; biphenylenes (e.g., 4,4′-biphenylene and 3,3′-biphenylene); and bisphenol residues (e.g., 1,4-phenyleneisopropylidene-1,4-phenylene (bisphenol A residue), 1,4-phenylenemethyl-ene-1,4-phenylene (bisphenol F residue), 1,4-phenylenecarbonyl-1,4-phenylene, 1,4-phenylenesulfonyl-1,4-phenylene (bisphenol S residue), 1,4-phenylenethio-1,4-phenylene, and 1,4-phenyleneoxy-1,4-phenylene).

The ratio of cross-linking group is 0.01-50 mol %, preferably 0.1-30 mol %, based on the total amount of R₆.

The phosphazenes can be prepared with any known method, such as the methods thereof described in JP2004-115815A , JP2002114981A or EP0945478A. The commercialized phosphazenes include Rabitle ® Series of FUSHIMI Pharmaceutical Co. Ltd, and SPB-100, SPS-100 and SPE-100 of Otsuka Chemical Co. Ltd.

In one preferred embodiment of the present invention, the polyphenoxyphosphazene is of the formula (VII):

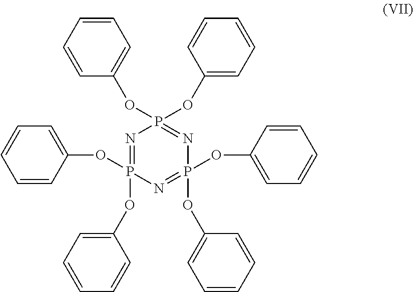 [SMILES: c1ccc(OP2(Oc3ccccc3)=NP(Oc3ccccc3)(Oc3ccccc3)=NP(Oc3ccccc3)(Oc3ccccc3)=N2)cc1]

The amount of the phosphazene (C) is preferable from 1 wt % to 4 wt %, more preferable from 2 wt % to 4 wt %, based on the total weight amount of the polyamide composition.

There is no limitation of the reinforcing agent (D) in the present invention, preferable is fibrous reinforcing agent. Examples of the reinforcing agents are glass fibers, carbon fibers, boron fibers, asbestos fibers, polyvinyl alcohol fibers, polyester fibers, acrylic fibers, wholly aromatic polyamide fibers, polybenzoxazole fibers, polytetrafluoroethylene fibers, kenaf fibers, bamboo fibers, hemp fibers, bagasse fibers, high strength polyethylene fibers, alumina fibers, silicon carbide fibers, potassium titanate fibers, brass fibers, stainless steel fibers, steel fibers, ceramic fibers and basalt fibers, preferable is glass fibers and carbon fibers.

The fiber length and the fiber diameter of the fibrous reinforcing agent are not particularly limited. The fiber length is preferably 2 to 7 mm and more preferably 3 to 6 mm. The fiber diameter is preferably 3 to 20 μm, more preferably 7 to 13 μm.

Examples of the cross-sectional shape of the fibrous reinforcing agent include a circle, a rectangle, an ellipse, and other non-circular cross sections, preferably is circle.

The glass fibers or carbon fibers are preferably surface-treated by a silane coupling agent, such as vinylsilane-based coupling agents, acrylic silane-based coupling agents, epoxysilane-based coupling agents and aminosilane-based coupling agents, preferable is aminosilane-based coupling agents. The silane coupling agent may be dispersed in a sizing agent. Examples of the sizing agents are acrylic compounds, acrylic/maleic derivative modified compounds, epoxy compounds, urethane compounds, urethane/maleic derivative modified compounds and urethane/amine modified compounds.
The amount of the reinforcing agent (D) is from 30 wt % to 50 wt %, preferable is from 35 wt % to 45 wt %, based on the total weight amount of the polyamide composition.

The polyamide composition could also comprise various conventional additives (E) so long as the additives and the amount thereof not significantly adversely affect the desired properties of the composition in the invention. The additives could include lubricants, surface effect additives, antioxidants, colorants, pigments, stabilizers (thermal, UV, radiation or hydrolysis stabilizers), flow modifiers, plasticizers, demolding agents, anti-drip agents, ultraviolet absorbing agents, nucleating agents, antistatic agents, elastomer modifiers, plasticizers, release agents and/or antimicrobial agents.

The lubricant is not particularly limited, such as an ester, amide, alkali metal salt, alkaline earth metal salt of fatty acids having from 10 to 40 carbon atoms (e.g., such as Ca stearate, Zn stearate, Mg behenate, Mg stearate), polyethylene wax, polypropylene wax, ester wax, EVA wax, oxidized polyethylene wax, fatty alcohols, fatty acids, montan wax, pentaerythrityl tetrastearate (PETS) and silicone wax. A preferred lubricant is ethylene bis stearamide.

The lubricant is preferably present in an amount of about 0 wt % to 3 wt %, more preferably of about 0.01 wt % to 2 wt %, or 0.2 wt % to 1 wt %, or 0.2 wt % to 0.8wt %, based on the total weight amount of the polyamide composition.

The antioxidant is not particularly limited, such as aromatic amine-based antioxidant agent, hindered phenol-based antioxidant agents, phosphite-based antioxidant agents, metal salts and iodides.
Examples of aromatic amine-based antioxidant agent are poly(1,2-dihydro-2,2,4-trimethyl-quinoline), bis(4-octylphenyl)amine, 4,4′-bis(α,α-dimethylbenzyl)diphenylamine, N,N′-di-2-naphthyl-p-phenylenediamine, N,N′-diphenyl-p-phenylenediamine, N-phenyl-N′-isopropyl-p-phenylenediamine, N-phenyl-N′-(1,3-dimethylbutyl)-p-phenylenediamine, N-phenyl-N′-(3-methacryloyloxy-2-hydroxypropyI)-p-phenylenediamine, N,N′-bis(methylphenyI)-1,4-benzenediamine and hydrazine derivatives.

Examples of hindered phenol-based antioxidant agents are poly(oxy-1,2-ethanediyl)-alpha-[3-[3,5-bis(1,1-dimethylethyl)-4-hydroxyphenyl]-1-oxopropyl]- omega-[3-[3,5-bis(1,1-dimethylethyl)-4-hydroxyphenyl]-1-oxopropoxy], 2,4-bis[(octylthio)methyl]-o-cresol, octyl-3,5-di-tert-butyl-4-hydroxy-hydrocinnamate, 3,5-bis(1,1-dimethylethyl)-4-hydroxybenzenepropanoic acid C7-C9-branched alkyl ester. And preferably the solid hindered phenol-based antioxidant agent is one or more selected from group “B-S” consisted of 2,4-bis[(dodecylthio)methyl]-o-cresol, 4,4′-butylidene bis-(3-methyl-6-tert-butylphenol), 3,5-bis(1,1-dimethylethyl)-4-hydroxybenzenepropanoic acid octadecyl ester, pentaerythritol tetrakis(3-(3,5-di-tert-butyl-4-hydroxyphenyl) propionate), triethylene glycol-bis[3-(3-tert-butyl-5-methyl-4-hydrophenyl) propionate], 2,4-bis(n-octylthio)-6-(4-hydroxy-3,5-di-tert-butylanilino)-1,3,5-triazine, tris-(3,5-di-tert-butyl-4-hydroxybenzyl)-isocyanurate, 2,2-thio-diethylene bis[3-(3,5-di-tert-butyl-4-hydroxyphenyl)propionate].

Examples of phosphite-based antioxidant agents are tris(2,4-di-tert-butylphenyl) phosphite (Irgafos® 168, BASF SE, CAS 31570-04-4), bis(2,4-di-tert-butylphenyl)pentaerythrityl diphosphite (Ultranox® 626, Chemtura, CAS 26741-53-7), bis(2,6-di-tert-butyl-4-methylphenyl)pentaerythrityl diphosphite (ADK Stab PEP-36, Adeka, CAS 80693-00-1), bis(2,4-dicumylphenyl)pentaerythrityl diphosphite (Doverphos® S-9228, Dover Chemical Corporation, CAS 154862-43-8), tris(nonylphenyl) phosphite (Irgafos® TNPP, BASF SE, CAS 26523-78-4), (2,4,6-tri-t-butylphenol)-2-butyl-2-ethyl-1,3-propanediol phosphite (Ultranox® 641, Chemtura, CAS 161717-32-4) and Hostanox® P-EPQ.

Examples of commercial antioxidant are the combination of copper salts with iodides, such as Brüeggolen® H3350 from Brüggemann-Gruppe, or Polyade® PB201 from PolyAd Services.

The antioxidant agent is preferably present in an amount of about 0 wt % to 2 wt %, more preferably of about 0.01 wt % to 1 wt %, and most preferably of about 0.1 wt % to 0.8 wt %, each based on the total weight amount of the polyamide composition.

The colorant is not particularly limited, such as carbon black, iron oxide, titanium dioxide, ultramarine blue, zinc sulfide, phthalocyanines, quinacridones, perylenes, nigrosin and anthraquinones.

The colorant is preferably present in an amount of about 0 wt % to 5 wt %, more preferably of about 0.01 wt % to 3 wt %, and most preferably of about 0.1 wt % to 2 wt %, based on the total weight amount of the polyamide composition.

The stabilizer is preferably present in an amount of about 0 wt % to 2 wt %, more preferably of about 0.01 wt % to 1 wt %, and most preferably of about 0.01 wt % to 0.5 wt %, each based on the total weight of the polyamide composition.

Examples of suitable nucleating agents are sodium phenylphosphinate or calcium phenylphosphinate, alumina (CAS No. 1344-28-1), talc, silicon dioxide, adipic acid and diphenylacetic acid.

Examples of suitable plasticizers are dioctyl phthalate, dibenzyl phthalate, butyl benzyl phthalate, hydrocarbon oils and N-(n-butyl)benzenesulphonamide.

The amount of all the additives in the present invention is preferably not more than 10 wt %, more preferably is 5 wt % or less, and most preferably is 2 wt % or less, based on the total weight amount of the polyamide composition.

The polyamide composition of the present invention has a heat distortion temperature of at least 265° C., preferably at least 270° C., measured according to method A of ISO 75-1/2.

The polyamide composition of the present invention has a tensile stress of higher than 99 MPa, measured by the samples having thickness of 0.4 mm according to ISO 527-2.

In the preferred embodiment, the polyamide composition comprising as component (A) 40 to 55 wt % the of long-chain semi-aromatic polyamides; as component (B) 10 to 20 wt % of the flame-retardant system; as component (C) 2 to 4 wt % of the phosphazene; and as component (D) 30 to 45 wt % of reinforcing agent, based on the total weight of the polyamide composition.

In the preferred embodiment, the polyamide composition comprising:

as component (A) 40 to 55 wt % the of long-chain semi-aromatic polyamides selected from the group consisting of PA9T, PA10T, PA11T, PA12T, PA13T, PA14T PA6T/8T, PA10T/6T, PA10T/610, PA6T/610, PA5T/510 and/or PA4T/410, preferably is PA9T, PA10T, PA11T, PA10T/6T PA10T/610 and/or PA5T/510;
as component (B) 10 to 20 wt % of the flame-retardant system comprising (B-1) dialkylphosphinate selected from aluminum diethylphosphinate, zinc diethylphosphinate, aluminum dimethylphosphinate and zinc dimethylphosphinate; and (B-2) metal salt of phosphorous acid selected from the group consisting of Al(H₂PO₃)₃, Al₂(HPO3)₃, Zn(HPO₃), Al2(HPO₃)₃.4H₂O and Al(OH)(H₂PO₃)₂.2H₂O;
as component (C) 2 to 4 wt % of phosphazene having the formula (V), preferably is having the formula (VI);
as component (D) 30 to 45 wt % of glass fibers;
as component (E) 0-5 wt % of additives; such as 0-3wt % lubricant, 0-2wt % antioxidant, 0-2wt % stabilizer; all based on the total weight of the polyamide composition.

The present invention also provides a process for the production of polyamide composition. The polyamide composition of the present invention may be produced by various known methods. For example, it is possible to add all components other than polyamide resin during the polymerization or polycondensation of the polyamide resin or add all components other than polyamide resin into the polyamide in the compounding process.

The polyamide composition according to the present invention may be prepared or processed through an extruder, preferably under the process temperature of 260-330° C. by introducing the long chain semi-aromatic polyamides (A), the flame-retardant system (B), phosphazene (C) and optional additives (E) in a feeding zone and introducing the reinforcing agent (D) in a downstream feeding zone, kneading and extruding. It is to be understood that the components may be introduced via different hoppers depending on the forms or properties thereof, in case that the components are introduced into the same feeding zone.

The present invention also provides any article obtained or obtainable by the polyamide composition which has a heat distortion temperature of at least 265° C. measured according to method A of ISO 75-1/2 and maximum working frequency of higher than 3.2 GHz, preferable higher than 6.4 GHz.

The examples of the articles in the present invention could be the connector sockets, antenna frame, circuit boards, circuit breakers, coil elements, frame/housing/package of cell phones, sensors or laptops. The connector sockets preferably have a maximum working frequency of the socket is higher than 3.2 GHz, more preferably is higher than 6.4 GHz, or 6.4 GHz to 6.5 GHz.

In one embodiment of the present invention, the connector sockets are the sockets for random access memory (RAM), central process unit (CPU) or solid state memory, preferably for the RAMs of DDR5.

In one embodiment of the present invention, the connector sockets are fine pitch electrical connector sockets, comprising at least two opposing walls, and a passageway defined between the opposing walls for receiving an insert with contact pins, wherein the opposing wall and contact pins are formed from the polyamide composition of the present invention, the wall having a terminal portion. The thickness of the terminal portion is preferably lower than 5.9 mm, more preferably is from 5.8 to 5.4 mm, the thickness is measured in the inserting direction of the insert. The width of the contact pins is preferably from 0.2 mm to 0.4 mm. The polyamide composition shows a tensile stress of higher than 99 MPa, measured by the samples having thickness of 0.4 mm according to ISO 527-2. The fine pitch electrical connector sockets are the fine pitch electrical connector sockets of random access memory of DDR5.

### ADVANTAGEOUS EFFECT OF THE INVENTION

DDR5 RAM is designed to double the speed of DDR 4, which has higher mounting density and stricter requirement on material dimensional stability, flowability and blistering control. The polyamide composition of the present invention shows desirable tensile strength for the article with thin thickness of 0.4 mm, well flowability, high HDT which make it could be applied in electronic component with high work frequency. Except for the tensile properties, flowability, the composition also exhibits good thermal stability during molding, approaches UL 94 V-0 which is also the critical feature for the thin thickness components in the E&E, especially DDR 5 application.

### BRIEF DESCRIPTION OF THE DRAWINGS

FIG. 1 is an illustration of a wall of a RAM connector socket of the invention.

FIG. 2 is a graph of reflow process temperature vs reflow process time in blister test.

### EXAMPLES

Hereinafter, the present invention will be detailed with reference to Examples, which however shall not be construed as limiting the scope of the present invention. In examples and comparative examples, measurements and evaluations of physical properties are made as described below.

(A) PA9T from Kuraray Co., Ltd. (with viscosity number to ISO307,1157,1628 of 79 cm³/g, number-average molar mass molecular weight (Mn) of 9600 g/mol)

(B) Exolit OP1400 from Clariant Plastics & Coating Ltd., mixture of about 80 wt % of aluminum salt of diethylphosphinic acid and about 20 wt % of aluminum salt of phosphorous acid;

(C1) SPB 100 from Otsuka Chemical Co., Ltd., cyclic phenoxyphosphazene having formula (VI).

(C2) OGSOL MF-11, flow improver from OSAKA GAS Chemicals Co. Ltd.

(C3) Joncryl® ADD 3310, acid-functional styrene/acrylic polymer from BASF.

(D) HP 3610 from PPG Industries Inc., glass fiber with diameter of 10 μm and length of 4.5 mm.

(E-1) Polyad® PB 201 from PolyAd Services GmbH combination of CuI 80 wt %, KI 10 wt % and Zn stearate 10 wt %.

(E-2) EBS (ethylene bis stearamide) from Croda Trading (Shanghai) Co., ltd.

(E-3) Carbon black from Orion Engineered Carbons.

### Examples 1-5 and Comparative Examples 1-8

The formulations for the examples and comparative examples 1-6 are shown in the following Table 1. The raw materials are mixed together in a Turbula T50A high-speed stirrer, fed into a Coperion ZSK26MC twin-screw extruder, melt-extruded under a temperature of 320° C., pelletized, thus obtaining a semi-aromatic polyamide composition in a pellet form.

The dried pellets were processed in an injection molding machine KM130CX, from Krauss Maffei with a clamping force of 130 T at melt temperatures of 300° C. to 330° C. to give test specimens.

Flow length was measured using a spiral flow tooling with a spiral runner. The cross section of the spiral runner has a thickness of 2 mm and width of 5.5 mm, numbered and subdivided centimeters are marked along the runner. The test material was melted at 320° C., then the melt was injected into the spiral runner under 500 bar pressure and 140° C. The spiral runner was filled from a sprue at the center of the spiral runner, and the pressure and temperature were maintained until the melt stopped, the mark number just at the tip of spiral melt giving the flow length.

Tensile stress at break and tensile strain at break for samples having thickness of 4 mm were measured according to ISO 527-1-2012. Test specimens of type 1 described in ISO 527-1-2012 were used.

Tensile stress at break and tensile strain at break for samples having thickness of 0.4 mm were measured according to ISO 527-1-2012. Test specimens having the shape of type 5A described in ISO 527-1-2012 were used. The dimensions of the test specimens are as below: over length I₃=75 mm, length of narrow parallel-sided portion I₁=25 mm, initial distance between grips L=50 mm, gauge length L₀=20 mm, width at narrow portion b₁=4 mm, width at ends b₂=12.5 mm, large radius r₂=12.52 mm, small radius r₁=8 mm, and thickness h=0.4 mm. The definitions of I₁, I₃, L, L₀, b₁, b₂, r₁, r₂and h are the same as in ISO 527-2-2012.

Charpy notched impact strength and Charpy unnotched impact strength was tested according to ISO 179-1-2010 via edgewise impact.

The test specimens for Charpy unnotched test is type 1 specimen with the dimensions of 80*10*4 mm (length*width* thickness). The test specimens for Charpy notched test is type 1 with notched type A. All the test specimens were conditioned at 23° C. and 50% relative humidity for 16 h. The tests were conduced under the same atmosphere as conditioning.

HDT was tested according to method A of ISO 75-2-2013 under 1.8 MPa.

The UL 94 fire classification were tested using sample sizes of 127 mm*12.7 mm*0.4 mm (length*width*thickness), 127 mm*12.7 mm*0.8 mm, and 127 mm*12.7 mm*1.6 mm.

Comparative examples 1-2, 7-8 shows that the addition of phosphazene, and commercialized flow improver, the flowability is increased but the mechanical properties of the composition, such as HDT, tensile properties decrease. Phosphazene and acid-functional styrene/acrylic polymer decreases the tensile properties of samples with both 4 mm and 0.4 mm thickness, especially for samples with 0.4 mm thickness. The flame retardancy of C1 and C2 could only approach V-2 for the samples with 0.4 mm thickness. The tensile property of samples having 4 mm thickness is increased by the addition of OGSOL MF-11, however the tensile property for 0.4 mm thickness and HDT are decreased.

Examples 1-5 and comparative example 2 show that the tensile property for the samples having thickness of 4 mm are maintained within the amount of phosphazene in 1˜4 wt % and drops heavily when the amount of phosphazene is 5 wt %. Meanwhile, the composition exhibits excellent tensile properties in the thickness of 0.4 mm within the phosphazene amount of 1˜4.8 wt %, and the glass fiber amount of 30-50wt %, this could well fulfil the requirement of electronic articles with maximum working frequency of higher than 3.2 GHz.

### Examples 6

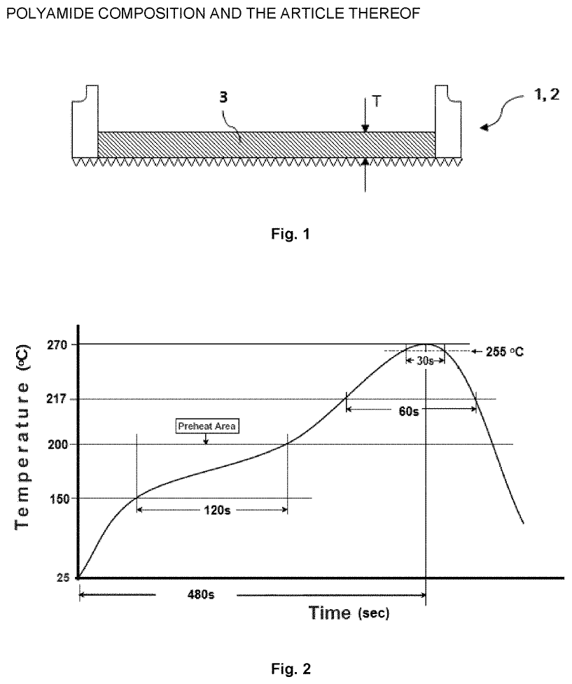

Connector sockets shown in FIG. 1 were prepared of polyamide composition of examples 1-5 via injection molding. The connect sockets comprise two opposing walls 1, 2 with length of 142 mm and a passageway defined between the opposing walls 1, 2 for receiving a memory chip or other insert with contact pins, each wall has a terminal portion 3 with thickness T of 5.4 mm. The width of the contact pins is 0.2 mm to 0.4 mm.

Blister Test During Reflow Process:

The polyamide compositions of examples 1-5 were injection molded into test pieces (length: 64 mm, width: 6 mm, thickness: 0.4 mm).

The reflow process was conducted according to IPC/JEDEC J-STD-020D.1 (Joint Industry Standard). The connector sockets were subjected to moisture soak at 85° C. and a relative humidity of 85% for 168 hours. A reflow process was performed in accordance with the temperature profile shown in FIG. 2. Referring to FIG. 2, the test pieces were heated to 217° C. and then heated to 255° C. for 30 s, the peak temperature is 270° C., then cooled back to 217° C., and cooled back to 25° C. (cycle 1). Performing the above reflow process for the other two times, and visual inspecting the blister on the surface of the connector sockets. From the above reflow process the peak temperature was found at which the sockets were not molten, and no blister was observed on the surface. After the 3-cycle reflow process, there is still no blister occurs in the sockets.

DDR 5 Application Test:

The connect sockets were tested according to JEDEC DDR5 standard in JEDEC'S JC-42 COMMITTEE. All the connectors passed the application test.

TABLE 1

| Component (wt %) | C1 | C2 | C3 | E1 | E2 | E3 | C4 | C5 | C7 | C8 | E4 | C6 | E5 |
|---|---|---|---|---|---|---|---|---|---|---|---|---|---|
| (A) | 54.61 | 54.61 | 44.61 | 44.61 | 45.61 | 44.61 | 44.61 | 46.61 | 45.61 | 45.61 | 46.61 | 34.61 | 34.61 |
| (B) | 19 | 17 | 19 | 18 | 17 | 15 | 14 | 17 | 17 | 17 | 15 | 19 | 17 |
| (C1) | — | 2 | — | 1 | 2 | 4 | 5 | — | — | — | 2 | — | 2 |
| (C2) | — | — | — | — | — | — | — | — | 2 | — | — | — | — |
| (C3) | — | — | — | — | — | — | — | — | — | 2 | — | — | — |
| (D) | 25 | 25 | 35 | 35 | 35 | 35 | 35 | 35 | 35 | 35 | 35 | 45 | 45 |
| (E-1) | 0.12 | 0.12 | 0.12 | 0.12 | 0.12 | 0.12 | 0.12 | 0.12 | 0.12 | 0.12 | 0.12 | 0.12 | 0.12 |
| (E-2) | 0.6 | 0.6 | 0.6 | 0.6 | 0.6 | 0.6 | 0.6 | 0.6 | 0.6 | 0.6 | 0.6 | 0.6 | 0.6 |
| (E-3) | 0.67 | 0.67 | 0.67 | 0.67 | 0.67 | 0.67 | 0.67 | 0.67 | 0.67 | 0.67 | 0.67 | 0.67 | 0.67 |
| Flow length 2 m (cm) | 61 | 63 | 52 | 58 | 60 | 61 | 63 | 56 | 54 | 58 | 60 | 51 | 53 |
| Tensile stress, | 121 | 119 | 158 | 160 | 159 | 159 | 140 | 156 | 160 | 132 | 153 | 149 | 150 |
| thickness = 4.0 mm | | | | | | | | | | | | | |
| (MPa) | | | | | | | | | | | | | |
| Tensile strain, | 2.0 | 2.0 | 1.9 | 1.9 | 2.0 | 2.0 | 1.8 | 1.9 | 1.9 | 1.6 | 1.8 | 1.3 | 1.4 |
| thickness = 4.0 mm | | | | | | | | | | | | | |
| (%) | | | | | | | | | | | | | |
| Tensile stress, | 99 | 92 | 95 | 99 | 100 | 103 | 96 | 98 | 94 | 84 | 106 | 93 | 98 |
| thickness = 0.4 mm | | | | | | | | | | | | | |
| (MPa) | | | | | | | | | | | | | |
| Tensile strain, | 1.8 | 1.6 | 1.0 | 1.2 | 1.3 | 1.5 | 1.2 | 1.1 | 1.1 | 0.9 | 1.4 | 0.8 | 1 |
| thickness = 0.4 mm | | | | | | | | | | | | | |
| (%) | | | | | | | | | | | | | |
| Charpy notched impact | 9 | 10 | 15 | 15 | 16 | 14 | 15 | 14 | 14 | 13 | 15 | 15 | 17 |
| strength (KJ/m²) | | | | | | | | | | | | | |
| Charpy unnotched impact | 45 | 43 | 57 | 56 | 59 | 60 | 56 | 57 | 52 | 48 | 60 | 41 | 45 |
| strength (KJ/m²) | | | | | | | | | | | | | |
| HDT method A, T_{ff} 1.8 | 270 | 268 | 274 | 272 | 271 | 273 | 268 | 272 | 265 | 268 | 272 | 275 | 271 |
| (° C.) | | | | | | | | | | | | | |
| UL94 test at 0.4 mm | V-2 | V-2 | V-0 | V-0 | V-0 | V-0 | V-0 | V-0 | V-0 | V-2 | V-0 | V-0 | V-0 |
| thickness | | | | | | | | | | | | | |
| UL94 test at 0.8 mm | V-1 | V-2 | V-0 | V-0 | V-0 | V-0 | V-0 | V-0 | V-0 | V-0 | V-0 | V-0 | V-0 |
| thickness | | | | | | | | | | | | | |
| UL94 test at 1.6 mm | V-0 | V-0 | V-0 | V-0 | V-0 | V-0 | V-0 | V-0 | V-0 | V-0 | V-0 | V-0 | V-0 |
| thickness | | | | | | | | | | | | | |
| DDR 5 application | not | not | not | pass | pass | pass | not | not | not | not | pass | not | pass |

“C” stands for comparative examples,
“E” stands for example

1. A polyamide composition, comprising as component (A) 30 to 55 wt % of one or more long chain semi-aromatic polyamides, as component (B) 10 to 20 wt % of flame-retardant system, as component (C) 1 to 4.8 wt % of phosphazene and as component (D) 30 to 50 wt % of reinforcing agent, based on a total weight of the polyamide composition, wherein the flame-retardant system comprises (B-1) dialkylphosphinate of formula (I) and/or diphosphinic salt of formula (II) and (B-2) metal salt of phosphorous acid; 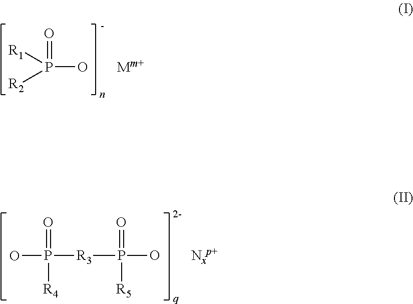
R₁ and R₂ are identical or different and are linear or branched C₁-C₆-alkyl;
M or N is Mg, Ca, Al, Sb, Sn, Ge, Ti, Zn, Fe, Zr, Ce, Bi, Sr, Mn, Li, Na, K, a protonated nitrogen base or a mixture thereof; m is an integer of 1 to 4; n is an integer of 1 to 4;
R₃ is linear or branched C₁-C₁₀-alkylene, C₆-C₁₀-arylene, C₇-C₂₀-alkylarylene or C₇-C₂₀-arylalkylene;
R₄ and R₅ are identical or different and are linear or branched C₁-C₆-alkyl;
q is an integer of 1 to 4; p is an integer of 1 to 4; x is an integer of 1 to 4.

2. The polyamide composition according to claim 1, wherein the one or more long chain semi-aromatic polyamides comprise polyamide (i) and/or polyamide (ii),
the polyamide (i) is derived from monomers comprising (A-1) dicarboxylic acids which comprise 60-100 mol % of terephthalic acid based on a total amount of the dicarboxylic acids, (A-2) diamines which comprise as component (a) aliphatic diamine having a carbon number of at least 8 in an amount of 60-100 mol % based on a total amount of the diamines, and optionally (A-3) amino acid and/or lactam;
polyamide (ii) is derived from monomers comprising (A-4) dicarboxylic acids which comprise 60-100 mol % of aliphatic dicarboxylic acid having a carbon number of at least 8 based on a total amount of the dicarboxylic acids, (A-5) diamines which comprise 60-100 mol % of aromatic diamine based on a total amount of the diamines, and optionally (A-3) amino acid and/or lactam.

3. The polyamide composition according to claim 1, wherein the aliphatic diamine (a) of polyamide (i) comprises from 8 to 36 carbon atoms;
and wherein the aliphatic dicarboxylic acid having the carbon number of at least 8 of polyamide (ii) cmprises from 8 to 36 carbon atoms.

4. The polyamide composition according to claim 1, wherein the one or more long chain semi-aromatic polyamides are selected from the group consisting of PAST, PA10T, PA1 1T, PA12T, PA13T, PA14T PA6T/8T, PA10T/6T, PA10T/610, PA6T/610, PA5T/510and PA4T/410.

5. The polyamide composition according to claim 1, wherein the one or more long chain semi-aromatic polyamides have a viscosity number of 60˜120 ml/g, which is measured in 96 wt % H₂SO₄ according to a method of ISO307-2007.

6. The polyamide composition according to claim 1, wherein the dialkylphosphinate of formula (I) is selected from the group consisting of calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphoshinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate and zinc methyl-n-propylphosphinate; wherein the diphosphinic salt of formula (II) is selected from the group consisting of calcium methanedi(methylphosphinate), magnesium methanedi(methylphosphinate), aluminum methanedi(methylphosphinate), zinc methanedi(methylphosphinate), calcium benzene-1,4-(dimethylphosphinate), magnesium benzene-1,4-(dimethylphosphinate), aluminum benzene-1,4-(dimethylphosphinate) and zinc benzene-1,4-(dimethylphosphinate); and wherein the metal salt of phosphorous acid is selected from the group consisting of Al(H₂PO₃)₃, Al₂(HPO₃)₃, Zn(HPO₃), Al2(HPO₃)₃4H₂O and Al(OH)(H₂PO₃)₂2H₂O.

7. The polyamide composition according to claim 1, wherein the components (B-1) and (B-2) are in a mass ratio of (B-1)/(B-2) from 60:40 to 90:10.

8. The polyamide composition according to claim 1, wherein the phosphazene (C) is at least one phosphazene selected from the group consisting of a cyclic phosphazene having the formula (V), a linear phosphazene having the formula (VI), and at least one phosphazene obtained by cross-linking the cyclic phosphazene or the linear phosphazene with a cross-linking group; 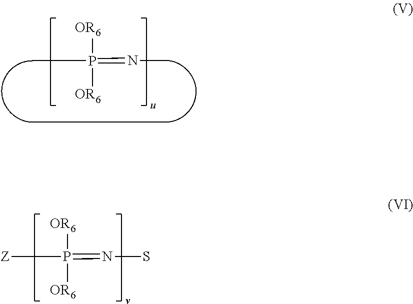
wherein each R₆ is identical or different and is C₁-C₂₀-alkyl, C₆-C₂₀-aryl, C₇-C₃₀-arylalkyl, or C₇-C₃₀-alkylaryl; u is an integer from 3 to 25; v is an integer of from 3 to 10,000; Z is —N═P(OR₆)₃ or —N═P(O)OR₆; S is —P(OR₆)₄ or —P(O)(OR₆)₂.

9. The polyamide composition according to claim 1, wherein the phosphazene is of the formula (VII):

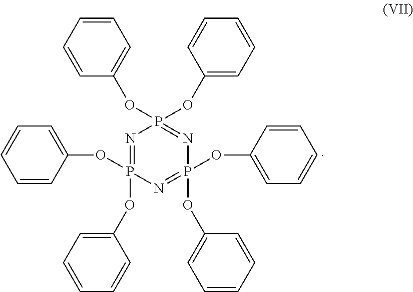 [SMILES: c1ccc(OP2(Oc3ccccc3)=NP(Oc3ccccc3)(Oc3ccccc3)=NP(Oc3ccccc3)(Oc3ccccc3)=N2)cc1]

10. The polyamide composition according to claim 1, wherein the reinforcing agent (D) is selected from the group consisting of glass fibers, carbon fibers, boron fibers, asbestos fibers, polyvinyl alcohol fibers, polyester fibers, acrylic fibers, wholly aromatic polyamide fibers, polybenzoxazole fibers, polytetrafluoroethylene fibers, kenaf fibers, bamboo fibers, hemp fibers, bagasse fibers, high strength polyethylene fibers, alumina fibers, silicon carbide fibers, potassium titanate fibers, brass fibers, stainless steel fibers, steel fibers, ceramic fibers and basalt fibers; wherein the fiber length is from 2 to 7 mm, and wherein the fiber diameter is from 3 to 20 μm.

11. The polyamide composition according to claim 1, wherein the polyamide composition has a heat distortion temperature of at least 265° C., measured according to method A of ISO 75-1/2.

12. The polyamide composition according to claim 1, wherein the polyamide composition has a tensile stress of higher than 99 MPa, measured using samples having a thickness of 0.4 mm of type 5A according to ISO 527-2.

13. An article obtained by the polyamide composition according to claim 1, wherein the article has a heat distortion temperature of at least 265° C. measured according to method A of ISO 75-1/2 and maximum working frequency of higher than 3.2 GHz.

14. The article according to claim 13, wherein the article is selected from the group consisting of connector sockets, an antenna frame, circuit boards, circuit breakers, coil elements, a frame or a housing or a package of cell phones, sensors and laptops.

15. The article according to claim 14, wherein the connector sockets are sockets for random access memory ora central process unit or solid state memory.

16. Connector sockets obtained by the polyamide composition according to claim 1, wherein the connector sockets are fine pitch electrical connector sockets, comprising at least two opposing walls, and a passageway defined between the opposing walls for receiving an insert with contact pins, wherein the opposing walls and the contact pins are formed from the polyamide composition, and wherein the opposing walls each comprise a terminal portion; wherein a thickness of the terminal portions is lower than 5.9 mm, and wherein the thickness is measured in an inserting direction of the insert; wherein a width of the contact pins is from 0.2 mm to 0.4 mm; and wherein the fine pitch electrical connector sockets are fine pitch electrical connector sockets of random access memory of DDR5.

17. The polyamide composition according to claim 1, wherein the aliphatic diamine (a) of polyamide (i) comprises from 8 to 36 carbon atoms, and is selected from the group consisting of 1,8-octanediamine, 1,9-nonanediamine, 1,10-decanediamine, 1,11-undecanediamine, 1,12-dodecanediamine, 1,13-tridecanediamine, 1,14-tetradecanediamine, 1,16-hexadecanediamine, 1,18-octadecanediamine, 1,20-eicosanediamine, 1,22-docosanediamine, 2-methyl-1,8-octanediamine, 5-methylnonane-1,9-diamine and 2,4-dimethyloctanediamine;
and wherein the aliphatic dicarboxylic acid having the carbon number of at least 8 of polyamide (ii) comprises from 8 to 36 carbon atoms, and is selected from the group consisting of pimelic acid, suberic acid, azelaic acid, sebacic acid, undecanedioic acid, dodecanedioic acid, tridecanedioic acid, tetradecanedioic acid, pentadecanoic acid, hexadecanedioic acid, octadecanedioic acid and C36 dimer acid.

18. The polyamide composition according to claim 1, wherein the phosphazene (C) is at least one phosphazene selected from the group consisting of a cyclic phosphazene having the formula (V), a linear phosphazene having the formula (VI), and at least one phosphazene obtained by cross-linking the cyclic phosphazene or the linear phosphazene with a cross-linking group; 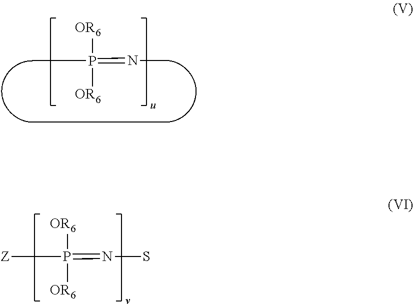
wherein each R₆ is identical or different and is C₁-C₂₀-alkyl, C₆-C₂₀-aryl, C₇-C₃₀-arylalkyl, or C₇-C₃₀-alkylaryl; u is an integer from 3 to 6; v is an integer of from 3 to 10,000; Z is —N═P(OR₆)₃ or —N═P(O)OR₆; S is —P(OR₆)₄ or —P(O)(OR₆)₂.

19. The polyamide composition according to claim 1, wherein the reinforcing agent (D) is selected from the group consisting of glass fibers, carbon fibers, boron fibers, asbestos fibers, polyvinyl alcohol fibers, polyester fibers, acrylic fibers, wholly aromatic polyamide fibers, polybenzoxazole fibers, polytetrafluoroethylene fibers, kenaf fibers, bamboo fibers, hemp fibers, bagasse fibers, high strength polyethylene fibers, alumina fibers, silicon carbide fibers, potassium titanate fibers, brass fibers, stainless steel fibers, steel fibers, ceramic fibers and basalt fibers; wherein the fiber length is from 2 to 7 mm, and wherein the fiber diameter is from 7 to 13 μm.

20. The polyamide composition according to claim 1, wherein the polyamide composition has a heat distortion temperature of at least 270° C., measured according to method A of ISO 75-1/2.
